(19) United States
(12) Patent Application Publication
(10) Pub. No.: US 2009/0078659 A1
(43) Pub. Date: Mar. 26, 2009

(54) Filtering Apparatus

(76) Inventors: Robert Whitlock, Queensland (AU); Thomas Anthony Vernon Shaw, Queensland (AU)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/861,368

(22) Filed: Sep. 26, 2007

(51) Int. Cl. B01D 17/12; B01D 17/09; B01D 35/26; B01D 35/18

(52) U.S. Cl. 210/773; 210/137; 210/149; 210/186; 210/241; 210/416.1; 210/742; 210/774

(57) ABSTRACT

A filtering apparatus for purifying cooking oil is provided. The filtering apparatus comprises a housing, a filter housing including a filter and a first conduit in communication with a deep fryer for extraction of cooking oil requiring purifying from the deep fryer. The apparatus further comprises a pump for pumping cooking oil through the first conduit, a valve assembly in flow communication with the pump, and a second conduit in flow communication with the pump which transports cooking oil to the filter housing. The filtering apparatus also comprises one or more heating cables attached to the first and second conduits and located adjacent the pump and valve assembly, and a thermostat in communication with a thermostat probe attached to the first and second conduits and the valve assembly and pump, whereby use of the thermostat prevents activation of said one or more heating cables when activation is not required.

### BACKGROUND OF THE INVENTION

This invention relates to an improved filtering apparatus especially useful for use in cold climates.

### SUMMARY OF THE INVENTION

Reference may be made to conventional filtering apparatus for purifying cooking oil as described in Australian specifications 2005201177 and 749466 which each refer to a mobile trolley having ground supporting wheels which trolley has a reservoir, a filter housing located in the reservoir containing a filter, a pump located below the reservoir, a valve assembly in flow communication with the pump, an electric motor for driving the pump, a first conduit in communication with the pump for extraction of cooking oil from a deep fryer located adjacent the filtering apparatus in use, a second conduit which placed the pump in communication with the filter housing for pumping cooking oil through the filter and an electric switch for controlling or directing the flow of cooking oil to and from the reservoir.

Such conventional filtering apparatus was found to be deficient in that in cold weather and in colder climates generally it was found that canola oil in the first and second conduits discussed above congealed or coagulated in temperatures of around 10° C. It was also found that solid cooking fats, tallow, palm oils and shortening which form significant components of the cooking oil also had a tendency to solidify even at temperatures approaching 30° C. and this meant that all conduits, the pump and valves used in the filtering apparatus had to be cleaned of such solids before the filtering apparatus was usable. This cleaning process was time consuming.

From the foregoing it was therefore appreciated that conventional filtering apparatus could not be used effectively at low ambient temperatures and this meant loss of valuable business as well as providing undesired down time.

It is therefore an object of the invention to provide filtering apparatus which may be used in a variety of different temperatures including low ambient temperatures.

The filtering apparatus of the invention in one aspect includes a housing, a filter housing including a filter, a first conduit in use in communication with a deep fryer for extraction of cooking oil requiring purifying from the deep fryer, a pump for pumping of cooking oil through the first conduit, a valve assembly in flow communication with the pump and a second conduit in flow communication with the pump which transports cooking oil to the filter housing characterized in that (i) one or more heating cables are attached to the first and second conduits and are also located adjacent the pump and valve assembly and (ii) there is also provided a thermostat in communication with a thermostat probe which is also attached to the first and second conduits and the valve assembly and pump whereby use of the thermostat prevents activation of said one or more heating cables when such activation is not required.

The heating cables are suitably self regulating heating cables and will shut off when the temperature of the cables exceeds a certain temperature, e.g. 121° C. Thus they can be used effectively at temperatures which prevent solidification of the cooking oil. Thus for example (i) canola oil which solidifies at temperatures around 10° C. and (ii) cooking oil containing beef tallow, shortening or palm oils which solidifies around 30° C. will be prevented from solidifying by the heating cables. However it is important to preserve the operational longevity of the heating cables and thus use of the thermostat will ensure that the heating cables are not activated when such activation is not required. Thus for example when the ambient temperature is greater than 10° C. in the case of canola oil or greater than 30° C. in the case of cooking oil containing beef tallow or palm oils the thermostat by being kept at 0° C. will prevent activation of the heating cables.

Therefore the invention in another aspect refers to a method of operation of filtering apparatus for filtering cooking oil from a deep fryer which includes the steps of:

(i) activating heating cable(s) located adjacent to conduits used for transporting cooking oil from the deep fryer to a cooking oil filter located within the filtering apparatus to prevent solidification of said cooking oil within said conduits; and

(ii) inactivating said heating cable(s) when required by connection of said heating cable(s) to a thermostat which is maintained at a temperature to cause said inactivation.

The probe which is connected to each of the conduits as well as the pump and valve assembly will measure the outside temperature of the conduits, pump and valve assembly and ensures correct operation of the thermostat which may be set at 160° C. for example.

Thus from the foregoing it will be appreciated that the provision of the heating cables in conjunction with the thermostat will provide filtering apparatus that can be used in a hot climate or hot conditions as well as cold ambient temperatures. This could not be achieved with the prior art.

Preferably there are provided a plurality of heating cables and conveniently a pair of heating cables may be used wherein one heating cable is located along the first conduit, the pump and/or the valve assembly and the second heating cable may be located along the second conduit, the valve assembly and/or the pump. Preferably each heating cable terminates adjacent the valve assembly and may be connected by a connector which is electrically connected to the thermostat.

However it will be appreciated that a plurality of heating cables may be used each connected by a connector which is in electrical association with the thermostat.

### BRIEF DESCRIPTION OF THE DRAWINGS

The present invention can be more fully understood by reading the following detailed description of the presently preferred embodiments together with the accompanying drawings, in which like reference indicators are used to designate like elements, and in which:

FIG. 1 is a side perspective view of the filtering apparatus;

FIG. 2 is a side view of the filtering apparatus shown in FIG. 1;

FIG. 3 is a detailed view of the connection of the heating cable at each end to an adjacent conduit;

FIG. 4 is a detailed view of a protective cover for the heating cable as well as the thermostat probe; and

FIG. 5 is a front view of the filtering apparatus showing the location of the reversing switch connected to the pump and the thermostat.

### DETAILED DESCRIPTION OF THE INVENTION

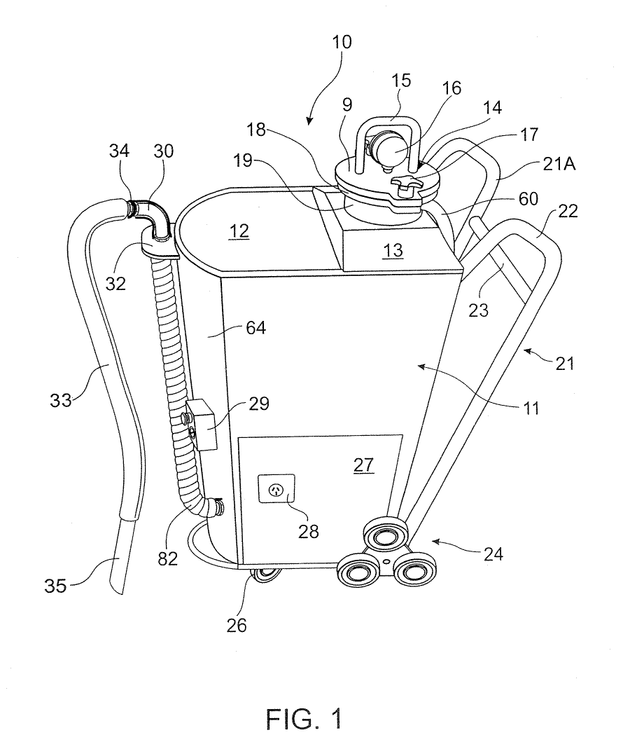

In the drawings and in particular in FIG. 1, there is shown filtering apparatus 10 having a housing 11, top wall 12, abutment 13, lid or cover assembly 14 having a cover 9, handle 15, pressure gauge 16, releasing knob 17, mounting flange 18 and side wall 19. There is also provided conduit 60.

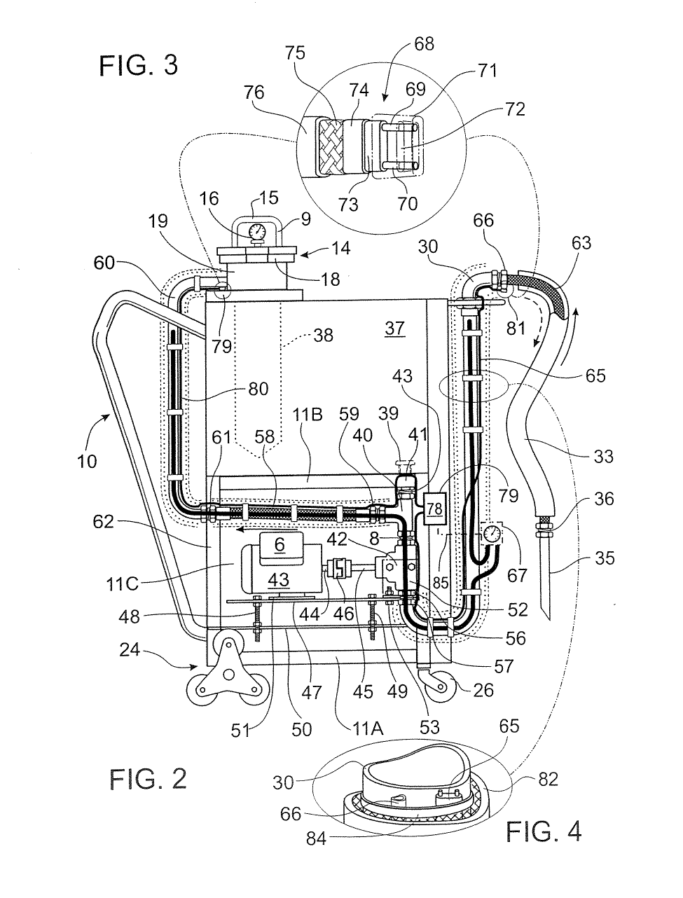

There is also provided a handle assembly 21 which comprises a pair of handles 21A and 22 interconnected by brace 23, a rear pair of wheel assemblies 24 and a front pair of castor wheels 26. There is also provided inspection or maintenance cover 27, power point 28, reversing switch 29, conduit 30 having protective sheath 82, mounting flange 32 for conduit 30 and hose 33 connected to conduit 30 by coupling 34. Hose 33 is also provided with a nozzle 35 attached to hose 33 by coupling 36 shown in FIG. 2. Nozzle 35 may extend into a deep fryer (not shown) for extraction of oil when required. It will be appreciated that power point 28 may also be located in a rear wall of housing 11.

In FIG. 2 there is further shown reservoir 37 for containing cooking oil in use. Housing 11 is also provided with base wall 11A and intermediate wall 11B which separates reservoir 37 from bottom compartment 11C. Filter housing 38 is also shown having lid or cover assembly 14. Filter housing 38 contains a cloth filter (not shown), drain plug 39, control valve 40 which interconnects drainage conduit 41 and pump 42 which is a gear type pump, coupling 43 between drainage conduit 41 and valve 40, coupling 8 between valve 40 and pump 42, electric motor 43 having gearbox 6 and output shaft 44 coupled to input shaft 45 of pump 42 by coupling device 46, base plate 47 for supporting motor 43 and pump 42, fastening assemblies 48 and 49 for attaching base plate 47 to frame member 50 of housing 11, attachment flange 51 of motor 43 which is attached to base plate 47 by suitable fasteners (not shown) and vertically oriented support plate 52 and fastening assemblies 53 attaching pump 42 to base plate 47.

Conduit 30 which is rigid is connected to pump 42 by flanges 56 and 57 which abut base plate 47. Flange 56 defines an inlet (not shown) of pump 42.

Valve 40 is connected to flexible hose 58 by coupling 59 and hose 58 is attached to rigid pipe or conduit 60 by coupling 61 which extends through wall 62 of housing 11. Conduit 60 then extends upwardly to communicate with filter housing 38. In this embodiment conduit 60 is attached to side wall 19 of cover 14.

The provision of rear wheel assemblies 24 enable the housing 11 to be walked up and down stairs and handle assembly 21 has handles 21A and 22 which each diverge outwardly and upwardly from an adjacent wheel assembly 21 so that when laid rearwardly the housing 11 is supported by handle assembly 21 and rear wheel assemblies 24 with reservoir 37 being slightly inclined towards an upright position. This will prevent spillage of any residual oil in reservoir 37 while filtering apparatus 10 is in transit when it is supported by handle assembly 21.

In use the passage of oil is shown by the arrows in full outline wherein oil is caused by the operation of pump 42 to travel up hose 33, then downwardly through conduit 30 for passage through pump 42 and subsequently through valve assembly 40, hose 58, conduit 60 and then into reservoir 37 after passage through filter body 38. When the reservoir 37 has reached maximum capacity whereby the oil has been filtered by passage through filter housing 38 the direction of flow of oil may be reversed by actuation of switch 29. Switch 29 is electrically connected to motor 43 and switch 29 includes an on/forward/reverse adjustment so that upon the switch 29 being moved to the reverse position pump 42 which is a reversible flow pump is transformed so that an inlet of the pump (not shown) becomes an outlet upon reversing of the direction of rotation of the electric motor 43.

After switch 29 is adjusted to the reverse position oil is then caused to travel from reservoir 37 through conduit 41, valve 40, pump 42, conduit 30 and hose 33 as shown by the arrow in phantom outline so that the deep fryer may be replenished with purified oil from nozzle 35 after being filtered by filtering apparatus 10. It will be noted that plug 39 is spaced from wall 11B so that oil may flow through conduit 41 when required.

There is also provided another valve (not shown) similar to valve 40 located at the bottom of pump 42 for removal of oil from pump 42 when required.

The placement of reversing switch 29 at a location externally of housing 11 is advantageous because in the prior art, i.e. Australian specification 2005201177 it was located within housing 11 above motor 43 and above hose 58 and attached to wall 11B. This was disadvantageous because it was considered a work place risk caused by an operator of the filtering apparatus 10 bending around housing 11 and being exposed to a hot reservoir 38 of oil when switching was either forward or reverse. This occurred each time the filtering apparatus was being serviced or had maintenance carried out. Another problem was that the location of reversing switch 29 as described above in Australian specification 2005201177 meant that actuation of the reversing switch was difficult in work areas such as kitchens where space was limited.

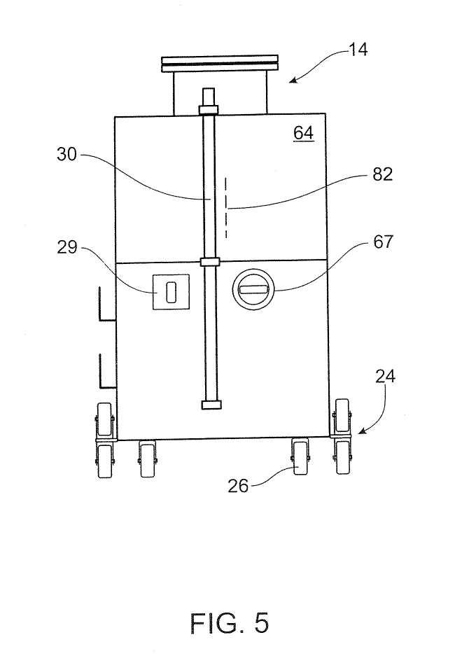

In FIG. 2 there is also described each rigid conduit 30, 60 as well as hoses 58 being enclosed in a protective sheath 82 which is indicated in phantom and which is more clearly illustrated in FIG. 4 wherein sheath 82 encloses conduit 30 as well as heating cable 65 and thermostat probe 66. The probe 66 is connected to thermostat 67 which is located adjacent to reversing switch 29 and attached to wall 64 as shown in FIG. 5. The thermostat is located as shown in FIG. 5 approximately level with the height of the valve 40 and is provided with one power inlet connector point (not shown) and one power outlet connector.

The heating cable 65 extends from coupling 66 at 81 interconnecting conduit 30 and flexible hose 30 and has an end connector 68 best shown in FIG. 3 wherein each of conductors or wires 69 and 70 are enclosed by a sheath 71 so that each of wires 69 and 70 may form a bridge at 72 for reversal of the flow of electric current. There is also provided a semi-conductive polymer core matrix 73, a high temperature fluoropolymer jacket 74, metallic braid 75 and a high temperature fluoropolymer overjacket 76. Matrix 73 has an electrical resistance that varies with temperature so that as the temperature drops, the heat output from matrix 73 increases whereas as the temperature rises, the heat output decreases.

The heating cable 65 continues along conduit 30 as shown, along pump 42 and terminates in connector 78 which is located in a recess 79 of housing 11 adjacent valve 40. The heating cable 80 which extends around or adjacent conduit 41 as shown, along coupling 59 and subsequently along hose 58 and then along conduit 60 where it terminates in an end connector as shown in FIG. 3 adjacent side wall 19 at 79.

Each of cables 65 or 80 are enclosed in a protective sheath 82 adjacent the relevant conduit. This is shown in FIG. 4 wherein heating cable 65 and thermostat probe 66 are enclosed by resilient band or tape 84 as well as sheath 82.

It also will be appreciated from FIG. 2 that each of the heating cables 65 and 80 are electrically connected to thermostat 67 as shown by line 85 in phantom and thus thermostat 67 is used to control the on-off function of heat cables 65 and 80 and also regulate heat. This enables filtering apparatus 10 to be usable in accordance with ambient temperatures and thermostat 67 is “heat rated” to withstand resilient heat from housing 11. The thermostat probe 83 is filled with alcohol and measures the temperature anywhere along conduit 60, hose 58, conduit 41, valve 40, pump 42 or conduit 30.

Protective sheath 82 has an inner layer of fiberglass and an outer layer of silicon and provides protection from burn injuries resulting from contact with conduits 30 and 60.

From the foregoing therefore it will be appreciated that the filtering apparatus 10 can be used in cold climates or in hot climates as may be required and thus represents a considerable advance over the prior art.

Self-regulation heating cables 65 and 80 are commercially available under the CHROMALOX trade mark and are described at www.heatersplus.com/srm-e.htm.

What is claimed is:

1. Filtering apparatus for purifying cooking oil, the filtering apparatus comprising:
a housing;
a filter housing including a filter;
a first conduit in communication with a deep fryer for extraction of cooking oil requiring purifying from the deep fryer;
a pump for pumping of cooking oil through the first conduit;
a valve assembly in flow communication with the pump;
a second conduit in flow communication with the pump which transports cooking oil to the filter housing;
one or more heating cables attached to the first and second conduits and located adjacent the pump and valve assembly; and
a thermostat in communication with a thermostat probe which is also attached to the first and second conduits and the valve assembly and pump whereby use of the thermostat prevents activation of said one or more heating cables when such activation is not required.

2. Filtering apparatus as claimed in claim 1 further comprising a plurality of heating cables which are each connected to each other by a connector which is in electrical association with the thermostat.

3. Filtering apparatus as claimed in claim 2 further comprising a pair of heating cables each connected by a single connector which is in electrical association with the thermostat.

4. Filtering apparatus as claimed in claim 3 wherein the single connector is located adjacent the valve assembly.

5. Filtering apparatus as claimed in claim 1 wherein the one or more heating cables and the thermostat probe are enclosed in a protective sheath.

6. A method of operation of filtering apparatus for filtering cooking oil from a deep fryer which includes the steps of:
(i) activating one or more heating cables located adjacent to conduits used for transporting cooking oil from the deep fryer to a cooking oil filter located within the filtering apparatus to prevent solidification of said cooking oil within said conduits; and
(ii) inactivating said one or more heating cables when required by connection of said one or more heating cables to a thermostat which is maintained at a temperature to cause said inactivation.

7. A method as claimed in claim 6 wherein said temperature in step (ii) is maintained at 0° C.

8. A method as claimed in claim 6 wherein the one or more heating cables are maintained at a temperature of 121° C.

9. Filtering apparatus for filtering of cooking oil from a deep fryer in the form of a mobile trolley having ground supporting wheels, the filtering apparatus comprising:
(i) a reservoir;
(ii) a filtering housing located in the reservoir containing a filter;
(iii) a pump located below the reservoir;
(iv) a valve assembly in flow communication with the pump;
(v) a first conduit in communication with the pump for extraction of cooking oil from the deep fryer in use;
(vi) a second conduit which places the pump in flow communication with the filter housing for pumping cooking oil through the filter; and
(vii) an electric switch for controlling or directing the flow of cooking oil to and from the reservoir which is located on an external surface of a side wall of the trolley adjacent the first conduit.
